(19) United States
(12) Patent Application Publication
(10) Pub. No.: US 2015/0132438 A1
(43) Pub. Date: May 14, 2015

(54) READY TO EAT COLD VEGETABLE CAKES WITH INGREDIENTS

(71) Applicant: Alice Chang, South Pasadena, CA (US)

(72) Inventor: Alice Chang, South Pasadena, CA (US)

(21) Appl. No.: 14/077,499

(22) Filed: Nov. 12, 2013

(51) Int. Cl. A23L 1/212; A23P 1/10; A23L 1/303; A23P 1/08; A23L 1/30; A23L 1/302

(52) U.S. Cl. CPC A23L 1/2128; A23L 1/3016; A23L 1/302; A23L 1/303; A23P 1/086; A23P 1/081; A23P 1/10
USPC 426/62; 426/61; 426/72; 426/73; 426/74; 426/92; 426/93; 426/94; 426/96; 426/101; 426/102; 426/573; 426/575; 426/576; 426/577; 426/578; 426/615; 426/617; 426/618; 426/623; 426/629; 426/630; 426/632; 426/634; 426/635; 426/637

(57) ABSTRACT

Cold and ready to eat vegetable cakes, and with a variety of ingredient combinations are suitable for healthy consumption. The vegetable cakes are soft in texture and high in nutrition. People can save the time and energy of preparing and cooking of the food. Serving size can be a single serving, and a six pack of serving. Vegetable cakes are also created as vegetable egg cakes, vegetable plus salt source cakes, vegetable seafood cakes, vegetable meat cakes, vegetable bubbles, vegetables balls, vegetable patties, and vegetable sausages. They can be served as cold and hot food for breakfast, lunch, snack, and dinner. They can also be used as animal food, baby food, for children with less teeth, for old people, and for sick people. Cold and ready to eat vegetable cakes with ingredients offer the consumers an easy and convenient way to obtain an affordable, nutritious, and delicious meal.

### CROSS-REFERENCE TO RELATED APPLICATION

### Copyright Notice

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

The following includes information that may be useful in understanding the present invention(s). It is not an admission that any of the information provided herein is prior art, or material, to the presently described or claimed inventions, or that any publication or document that is specifically or implicitly referenced is prior art.

### BACKGROUND OF THE INVENTION

1. Field of the Invention

The present invention relates generally to the field of comestibles and more specifically relates to ready to eat cold vegetable cakes with ingredients.

2. Description of the Related Art

Vegetables are typically high in nutritional value, including carbohydrates, vitamins, minerals, and antioxidants; much of which the human body needs to maintain good health. A lot of vegetables are hard in texture and require time for preparation and cooking, thus may be overlooked for eating. Some vegetables can be consumed raw, some may be eaten cooked, and some must be cooked in order to be edible. It is desirable that vegetables maintain a regular part of a person's diet; as such a convenient and tasty means for preparing them is desirable. A more efficient option is needed to provide vegetables for user consumption on a regular basis.

It is desirable to offer nutritious comestibles for consumption. Nutrition, if maintained, may help individuals avoid serious health problems. Vegetables are a healthy food choice; however they may not typically be offered in a conveniently readily edible form. For example many individuals eat vegetables in some form for breakfast; however vegetables in this traditional manner is not conducive to portability and is thus often eaten in the home before leaving for the day. Vegetables are an important source of protein and carbohydrates and are widely available for consumption. Further, Vegetables have significant amounts of fiber and soluble fiber. Soluble fiber can help lower blood cholesterol. Since people's schedules are busy, convenience may outweigh nutrition which is not desirable in the long-term. It is desirable to have foods such as vegetables that are nutritious and also convenient to eat. A more efficient option is needed wherein vegetables can be produced in such a form.

Various attempts have been made to solve the above-mentioned problems such as those found in U.S. Pat. and Pub. Nos. 2013/0156894; 8277858; 5747087; 8192784; 4059046; and 5264238. This art is representative of vegetables. None of the above inventions and This prior art is representative of comestibles relating to vegetables. None of the above inventions and patents, taken either singly or in combination, is seen to describe the invention as claimed.

Ideally, ready to eat cold vegetable cakes with ingredients should provide nutrition and convenience to consumers and, yet would be manufactured at a modest expense. Thus, a need exists for ready to eat cold vegetable cakes with ingredients to avoid the above-mentioned problems.

### BRIEF SUMMARY OF THE INVENTION

In view of the foregoing disadvantages inherent in the known vegetables related comestibles art, the present invention provides novel ready to eat cold vegetable cakes with ingredients. The general purpose of the present invention, which will be described subsequently in greater detail is to provide ready to eat cold vegetable cakes with a variety of ingredients. The invention is to provide people who shop for vegetables for food the option of getting processed and cooked vegetable cakes, cold and ready to eat.

A ready to eat cold vegetable cake product comprising: vegetable cake, having at least one vegetable, at least one liquid ingredient, and at least one binding agent. Flavorings and other ingredients cause the vegetable cakes to be flavored, as per consumer preference, for consumption. Various flavored versions of the vegetable cakes may be produced. Kits may be packaged with ingredients and sold for home cooking.

A method of preparing ready to eat cold vegetable cakes with ingredients comprises the steps of: stirring and mixing at least one vegetable with at least one liquid ingredient; boiling until texture of admixture is soft and smooth; removing remaining solid residue; adding ingredient, flavoring, and at least one binding agent as an admixture; forming vegetable cake; storing vegetable cake in a refrigerator to congeal and solidify; and optionally packaging to preserve freshness once solidified.

The present invention holds significant improvements and serves as a ready to eat cold vegetable cakes system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat cold vegetable cakes constructed and operative according to the teachings of the present invention.

FIG. 1 shows a perspective view illustrating a square packaging option for ready to eat cold vegetable cakes according to an embodiment of the present invention.

FIG. 2 is a perspective view illustrating a six-pack of individually packed ready to eat cold vegetable cakes portions ready to consume according to an embodiment of the present invention of FIG. 1.

FIG. 3 is a perspective view illustrating small spheres or bubbles of ready to eat cold vegetable cakes that may be mixed into drinks, food, and condiments according to an embodiment of the present invention of FIGS. 1 & 2.

FIG. 4 is a perspective view illustrating ready to eat cold vegetable cakes portions in the form of balls, patties, and sausages according to an embodiment of the present invention of FIG. 1.

FIG. 5 is a flowchart illustrating a method of preparing the ready to eat cold vegetable cakes according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a comestible and more particularly to ready to eat cold vegetable cakes with ingredients as used to improve the health of consumers. The purpose as previously mentioned is to create healthy comestibles by creating novel ready to eat cold vegetable cakes, and with a variety of ingredients. Cold and ready to eat vegetable cakes with ingredients save people the time and energy of preparing and cooking of the food. Cold and ready to eat vegetable cakes with ingredients offer the consumers an easy and convenient way to obtain an affordable, nutritious, and delicious meal.

A novel ready to eat cold vegetable cake product is created comprising: vegetable cake, having at least one vegetable, at least one liquid ingredient, and at least one binding agent.

The ready to eat cold vegetable cake product comprising vegetable cake is soft in texture, high in nutrition, and suitable for consumption by everybody, including animal, infant, small children, old people, and sick people.

The ready to eat cold vegetable cake product comprising vegetable cake can be served as breakfast, lunch, snack, and dinner.

The ready to eat cold vegetable cake product comprising vegetable cake with gelatin as at least one binding agent can be refrigerated to serve cold but not reheated, because gelatin from fish and animal congeals below 15 degrees Celsius (59 degrees Fahrenheit). The vegetable cake with at least one binding agent selected from the group consisting of beaten egg, egg white, and starch component can be served at room temperature, refrigerated to serve cold, and reheated to serve hot.

At least one vegetable having preparation selected from the group consisting of removing outer shell, peeling outer layer, slice into thin layer, grind into small particles, and cut into small pieces.

At least one vegetable is cooked by method selected from the group consisting of deep frying, boiling, steaming, roasting, frying, grilling, and baking, in order to soften the texture.

At least one vegetable is stirred, mixed, and cooked with at least one liquid ingredient until texture is soft and smooth, and any solid residues are removed.

At least one vegetable, at least one liquid ingredient, and at least one binding agent are stirred and mixed as an admixture. The vegetable cake is cooked by method selected from the group consisting of deep frying, boiling, steaming, roasting, frying, grilling, and baking.

Generally speaking, the vegetables used herein can include root vegetable, fruit vegetable, flower bud, flower, stem shoot, stem, leaf, bulb, cereal grain, nut, seed, bean, sea vegetable, and other types of vegetable. The root vegetable are starchy and may include ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, horseradish, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, tumeric, turnip, ulluco, wasabi, water caltrop, water chestnut, yalcon, yam, and the like. The fruit vegetable may include avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, and the like. The flower and flower bud may include artichoke, broccoli, caper, cauliflower, courgette flower, globe artichoke, squash blossom, and the like. The stem and stem shoot may include asparagus, prussian asparagus, bamboo shoot, celery, leek, wild leek, lemongrass, rhubarb, cardoon, kurrat, galangal, and the like. The leaf may include amaranth, arugula, beet green, bok choy, borage, broccoli rabe, brussel sprout, cabbage, catsear, celery, celtuce, chard, chaya, chickweed, chicory, chinese mallow, chive, choi sum, chrysanthemum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizards tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, and the like. The bulb may include cardoon, chive, florence fennel, elephant garlic, garlic, garlic chive, kohlrabi, onion, pearl onion, potato onion, spring onion, tree onion, welsh onion, quamash, scallion, shallot, and the like. The cereal grain may include rice, barley, oat, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, and the like. The nut and seed may include almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, and the like. The bean may include green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, wisteria, and the like. Sea vegetable may include aonori, arame, carola, caulerpa, dabberlocks, dulse, hijiki, kombu, layer, mozuku, nori, ogonori, sea grape, sea lettuce, sea weed, wakame, and the like. Other types of vegetable include truffle, mushroom, bean sprout, and the like.

The vegetable cake can include cereal grain cake (such as rice cake, oat cake, barley cake, corn cake), nut or seed cake (such as almond cake, chestnut cake, walnut cake, macadamia cake, sunflower seed cake, pumpkin seed cake), bean cake (such as soy cake, red bean cake, green bean cake, chickpea cake), ginseng cake, potato cake, taro cake, yam cake, carrot cake, turnip cake, onion cake, garlic cake, avocado cake, eggplant cake, zucchini cake, tomato cake, pumpkin cake, spinach cake, truffle cake, mushroom cake, bean sprout cake, and so on.

When the vegetable is cereal grain, a method of preparing ready to eat cold cereal cake comprising the steps of: stirring and mixing at least one cereal with at least one liquid ingredient; boiling until texture of admixture is soft and smooth; removing remaining solid residue; adding ingredient, flavoring, and at least one binding agent as an admixture; forming cereal cake; storing cereal cake in a refrigerator to congeal and solidify; and packaging to preserve freshness once solidified.

When the vegetable is nut or seed, a method of preparing ready to eat cold nut cake comprising the steps of: removing nut from plant; removing external layer of the nut thereby exposing a fleshy part of the nut; grinding the fleshy part of the nut into very fine particles; stirring and mixing at least one nut with at least one liquid ingredient; boiling until texture of admixture is soft and smooth; removing remaining solid residue; adding ingredient, flavoring, and at least one binding agent as an admixture; forming nut cake; storing nut cake in a refrigerator to congeal and solidify; and packaging to preserve freshness once solidified.

When the vegetable is bean, a method of preparing ready to eat cold bean cake comprising the steps of: removing bean from plant; removing the bean from pod; soaking the bean in soaking water at least one time; discarding a plurality of batches of the soaking water to leach out hard to digest complex sugars that cause flatulence and bloating; boiling the bean for 3 minutes in boiling water, then set aside for 3 to 4 hours; draining and discarding the boiling water and proceeding with cooking; cooking for 1 to 4 hours; draining the boiling water again; converting the bean into a paste with a masher to remove skin; frying the bean with cooking oil; stirring and mixing at least one bean with at least one liquid ingredient; boiling until texture of admixture is soft and smooth; removing solid residue; adding ingredient, flavoring, and at least one binding agent as an admixture; forming bean cake; storing bean cake in a refrigerator to congeal and solidify; and packaging to preserve freshness once solidified.

At least one liquid ingredient can include beverage, distilled water, mineral water, sports drink, tea drink, flower tea, root tea, herbal tea, mushroom tea, green tea, oolong tea, black tea, white tea, yellow tea, earl grey, darjeeling, coffee drink, soup stock, roasted cereal grain beverage, roasted nut and seed beverage, roasted bean beverage, malted drink, fruit juice, vegetable juice, fruit drink, vegetable drink, fruit skin drink, vegetable skin drink, plant drink, herb drink, soft drink, fruit punch, beer, wine, liquor, spirit, cocktail, alcoholic drink, yogurt drink, milk drink, mammal milk, plant milk, milk shake, whole milk, lowfat milk, nonfat milk, lactaid milk, chocolate milk, buttermilk, malted milk, soy milk, coconut milk, almond milk, vanilla milk, and so on. Other kinds of beverages may also be used. Different kinds of beverages can be mixed together.

At least one binding agent is an edible binder and is selected from the group consisting of protein component and starch component. The protein component having ingredient selected from the group consisting of gelatin, beaten egg, and egg white. The starch component having ingredient selected from the group consisting of vegetable gum, vegEtable starch, and vegetable flour. The vegetable gum having ingredient selected from the group consisting of agar, alginic acid, sodium alginate, carrageenan, gum arabic, gum ghatti, gum tragacanth, karaya gum, guar gum, locust bean gum, beta glucan, chicle gum, dammar gum, glucomannan gum, mastic gum, psyllium seed husk, spruce gum, tara gum, gellan gum, and xanthan gum. The vegetable starch and vegetable flour having ingredient selected from the group consisting of root vegetable, cereal grain, nut, seed, bean, pectin, sago, and tapioca. The ingredient can be cooked by method selected from the group consisting of mixing with water, boiling, and steaming. The gelatin from fish and animal congeals below 15 degrees Celsius (59 degrees Fahrenheit).

At least one binding agent selected from the group consisting of beaten egg and egg white is used to create vegetable egg cake. The vegetable egg cake can use milk as the beverage for making egg cake. The vegetable egg cake can also use other kind of beverage or a mixture of other kinds of beverage for making egg cake. The vegetable egg cake can be cooked by method selected from the group consisting of deep frying, roasting, baking, steaming, boiling, grilling, and frying.

The vegetable egg cake is created in form selected from the group consisting of having no outer layer; having an outer layer of casing selected from the group consisting of intestine, and cellulose; comprising at least one outer coating selected from the group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

The vegetable cake further comprising at least one flavoring ingredient causes the vegetables cake to be flavored for consumption, and selected from the group consisting of natural flavor, artificial flavor, fruit flavor, plant flavor, herb flavor, tea flavor, root flavor, flower flavor, flower bud flavor, pollen flavor, leaf flavor, stem flavor, stem shoot flavor, bulb flavor, seed flavor, nut flavor, bean flavor, cereal grain flavor, fruit skin flavor, vegetable oil flavor, vegetable fat flavor, vegetable skin flavor, and vegetable flavor, including hop, menthol, cordyceps, echinacea, elder, horehound, mallow, sage, thyme, cowslip, burnet, yarrow, marsh mallow, lady's mantle, speedwell, plantain, linden flowers, wild thyme, hyssop, eucalyptus, sea buckthorn, elder blossom, verbena, lemon balm, clove, coriander, cumin, basil, dill, rosemary, parsley, fennel, oregano, allspice, catnip, wormwood, musk, chili, horseradish, tumeric, mustard, curry, wasabi, mountain mint, peppermint, spearmint, wintergreen, cinnamon, licorice, rose, jasmine, chamomile, chrysanthemum, lavender, acacia, safflower, vanilla, alfafa, apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, lllawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, manila, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortiño, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, zig zag vine, ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, horseradish, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, tumeric, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, chrysanthemum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizards tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, layer, mozuku, nori, ogonori, sea grape, sea lettuce, sea weed, wakame, truffle, mushroom, bean sprout, acai, aloe vera, arnica, ashoka, asthma weed, astragalus, barberry, belladonna, bitter leaf, bitter orange, black cohosh, blessed thistle, cat's claw, cayenne, chaparral, chasteberry, cinchona, coffee senna, comfrey, digitalis, dong quai, ephedra, european mistletoe, evening primrose, fenugreek, feverfew, flaxseed, gingko, goldenseal, hoodia, horse chestnut, horsetail, jamaica dogwood, kava, khat, konjac, kratom, kanna, licorice root, marigold, moringa oleifera, milk thistle, neem, opium poppy, purple coneflower, passion flower, red clover, syrian rue, st john's wort, saw palmetto, tea tree oil, thunder god vine, tulasi, turmeric, umckaloabo, valerian, white willow, yerba santa, ajwain, akudjura, alexanders, alkanet, alligator pepper, angelica, anise, anise hyssop, aniseed myrtle, annatto, apple mint, artemisia, asafoetida, asarabacca, avens, avocado leaf, barberry, bay leaf, bee balm, boldo, borage, black cardamom, blue fenugreek, caraway, cardamom, cassia, cayenne pepper, celery leaf, celery seed, chervil, chicory, cicely, cilantro, clary, costmary, cubeb pepper, cudweed, culantro, curry leaf, curry plant, dill seed, epazote, fenugreek, file powder, fingerroot, galangal, galingale, ganoderma, golpar, grains of paradise, grains of selim, houttuynia cordata, huacatay, Indonesian bay leaf, jimbu, kaffir lime leaves, kala zeera, kawakawa seeds, kencur, keluak, kinh gioi, kokam seed, korarima, koseret leaves, lemon myrtle, lemon ironbark, lemon verbena, leptotes bicolor, lesser calamint, lime flower, lovage, mahlab, marjoram, mastic, mountain horopito, musk mallow, nasturtium, nigella, njangsa, neem, olida, orris root, pandan flower, pandan leaf, paprika, paracress, peppermint gum leaf, perilla, pandanus amaryllifolius, quassia, ramsons, rice paddy herb, rue, saffron, salad burnet, salep, sassafras, savory, silphium, shiso, sorrel, spikenard, star anise, sumac, sweet woodruff, tarragon, voatsiperifery, water-pepper, wattleseed, wild betel, willow herb, wood avens, and woodruff. At least one flavoring ingredient is used for vegetable cake in manner selected from the group consisting of outer coating, interior filing, and mixed in. At least one flavoring ingredient is in form selected from the group consisting of skin, skinned, unskinned, unshelled, cut, uncut, extract, juice, sauce, liquid, oil, gel, jelly, wax, cream, paste, powder, thin layer, and small pieces. At least one flavoring ingredient can be uncooked, and cooked by method selected from the group consisting of deep frying, sun drying, roasting, baking, steaming, boiling, grilling, and frying.

The vegetable cake further comprising at least one fruit flavor to make fruity flavored cake selected from the group consisting of apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, lllawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, manila, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortiño, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, and zig zag vine. At least one fruit flavor is used for vegetable cake in manner selected from the group consisting of outer coating, interior filing, and mixed in. At least one fruit flavor is in form selected from the group consisting of skin, skinned, unskinned, unshelled, cut, uncut, extract, juice, sauce, liquid, oil, gel, jelly, wax, cream, paste, powder, thin layer, and small pieces. At least one fruit flavor can be uncooked, and cooked by method selected from the group consisting of deep frying, sun drying, roasting, baking, steaming, boiling, grilling, and frying.

The vegetable cake further comprising at least one other flavoring ingredient selected from the group consisting of natural flavor, artificial flavor, artificial sweetener, salt, vinegar, sugar, syrup, honey, fudge, chocolate, royal jelly, jelly, pudding, custard, ice cream, gelato, sherbet, cake, biscuit, cookie, candy, crepe, pancake, donut, roll, pie, pastry, waffle, pita, tortilla, bread, taco, marshmallow, caramel, butterscotch, raisin, apple sauce, vegetable shortening, vegetable oil, vegetable fat, fish oil, fish liver oil, plant wax, animal wax, beeswax, carnauba wax, cream, sour cream, yogurt, butter, margarine, peanut butter, cheese, cream cheese, cottage cheese, mozzarella, mascarpone, ricotta, egg, glycerol, suet, lard, and malt. At least one other flavoring ingredient is used for vegetable cake in manner selected from the group consisting of outer coating, interior filing, and mixed in. At least one other flavoring ingredient is in form selected from the group consisting of extract, juice, sauce, liquid, oil, gel, jelly, wax, cream, paste, powder, thin layer, and small pieces.

The vegetable cake further comprising at least one nutritional ingredient which is essential nutrient selected from the group consisting of vitamin, dietary mineral, amino acid, and fatty acid. The vitamin includes vitamin A, vitamin B1, vitamin B2, vitamin B3, vitamin B5, vitamin B6, vitamin B7, vitamin B9, vitamin B12, vitamin C, vitamin D, vitamin E, and vitamin K. The dietary mineral includes calcium, phosphorus, potassium, sulfur, sodium, chlorine, magnesium, iron, cobalt, copper, zinc, molybdenum, iodine, selenium, manganese, nickle, chromium, fluorine, boron, and strontium. The amino acid includes histidine, isoleucine, leucine, lysine, methionine, cysteine, phenylalanine, tyrosine, threonine, tryptophan, and valine; said fatty acid includes alpha-linoleic acid, and linoleic acid. At least one nutritional ingredient is used for vegetable cake in manner selected from the group consisting of outer coating, interior filing, and mixed in. At least one nutritional ingredient is in form selected from the group consisting of extract, juice, sauce, liquid, oil, gel, jelly, wax, cream, paste, powder, thin layer, and small pieces.

The vegetable cake further comprising at least one health ingredient which includes medication and other health ingredient. The medication is mixed into the vegetable cake for ease of consumption. The other health ingredient is selected from the group consisting of electrolyte, lactase, yeast, propolis, and quinine. At least one health ingredient is in form selected from the group consisting of extract, juice, sauce, liquid, oil, gel, cream, paste, powder, thin layer, and small pieces.

The vegetable cake further comprising at least one food additive selected from the group consisting of acid, acidity regulator, alcohol, anticaking agent, antifoaming agent, antioxidant, bulking agent, coagulation agent, food coloring, color retention agent, emulsifier, flavor enhancer, flour treatment agent, gelling agent, glazing agent, humectant, leavening agent, tracer gas, preservative, stabilizer, sweetener, and thickener.

The vegetable cake further comprising at least one topping selected from the group consisting of chocolate, caramel, butterscotch, peanut butter, butter, margarine, vegetable shortening, vegetable oil, vegetable fat, fish oil, fish liver oil, plant wax, animal wax, beeswax, carnauba wax, sugar, syrup, honey, royal jelly, apple sauce, raisin, fruit, vegetable, fruit skin, vegetable skin, herb, cereal grain, nut, seed, bean, cheese, cream cheese, cottage cheese, mozzarella, mascarpone, ricotta, jelly, pudding, custard, ice cream, gelato, sherbet, yogurt, cake, biscuit, cookie, candy, crepe, pancake, donut, roll, pie, pastry, waffle, pita, tortilla, bread, taco, marshmallow, sour cream, cream, malt, egg, meat, and seafood. The topping is in form selected from the group consisting of extract, juice, sauce, liquid, oil, gel, jelly, wax, cream, paste, powder, thin layer, and small pieces. The topping can be uncooked, and cooked by method selected from the group consisting of deep frying, sun drying, roasting, baking, steaming, boiling, grilling, and frying.

The vegetable cake further comprising at least one salt source having a combination of ingredients selected from the group consisting of seafood, meat, and cheese, including seafood and meat, seafood and cheese, meat and cheese, seafood and meat and cheese. The seafood is selected from the group consisting of squid, cuttle fish, shrimp, crab, crayfish, octopus, clam, oyster, scallop, lobster, abalone, conch, jellyfish, prawn, krill, mussel, sea cucumber, sea urchin, eel, snail, shrimp roe, crab roe, lobster roe, fish roe, and fish. The meat is selected from the group consisting of chicken, duck, goose, turkey, quail, rabbit, sheep, goat, cow, pig, deer, bison, buffalo, crocodile, frog, turtle, snail, worm, bacon, sausage, animal tissue, animal organ, animal tongue, animal tail, animal feet, animal liver, animal stomach, animal intestine, animal brain, animal heart, animal skin, animal tendon, animal fat, animal bone marrow, and animal blood. At least one salt source is used for vegetable cake in manner selected from the group consisting of outer coating, interior filing, and mixed in. At least one salt source is selected from the group consisting of cut, uncut, slice into thin layer, cut into small pieces, and grind into small particles. At least one salt source can be cooked by method selected from the group consisting of deep frying, roasting, baking, steaming, boiling, grilling, and frying.

At least one salt source having a combination of ingredients is grinded to create vegetable plus salt source cake. The vegetable plus salt source cake is prepared with a small amount of at least one liquid ingredient. The vegetable plus salt source cake is having at least one binding agent selected from the group consisting of beaten egg, egg white, and starch component. The vegetable plus salt source cake is cooked by method selected from the group consisting of deep frying, roasting, baking, boiling, steaming, grilling, and frying.

The vegetable plus salt source cake is created in form selected from the group consisting of having no outer layer; having an outer layer of casing selected from the group consisting of intestine, and cellulose; comprising at least one outer coating selected from the group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

The vegetable cake further comprising at least one seafood flavor selected from the group consisting of squid, cuttle fish, shrimp, crab, crayfish, octopus, clam, oyster, scallop, lobster, abalone, conch, jellyfish, prawn, krill, mussel, sea cucumber, sea urchin, eel, snail, shrimp roe, crab roe, lobster roe, fish roe, and fish. At least one seafood flavor is used for vegetable cake in manner selected from the group consisting of outer coating, interior filing, and mixed in. At least one seafood flavor is selected from the group consisting of cut, uncut, slice into thin layer, cut into small pieces, and grind into small particles. At least one seafood flavor can be cooked by method selected from the group consisting of deep frying, roasting, baking, steaming, boiling, grilling, and frying.

At least one seafood is grinded and used as ingredient to create vegetable seafood cake. The vegetable seafood cake is prepared with a small amount of at least one liquid ingredient. The vegetable seafood cake is having at least one binding agent selected from the group consisting of beaten egg, egg white, and starch component. The vegetable seafood cake is cooked by method selected from the group consisting of deep frying, roasting, baking, boiling, steaming, grilling, and frying.

The vegetable seafood cake is created in form selected from the group consisting of having no outer layer; having an outer layer of casing selected from the group consisting of intestine, and cellulose; comprising at least one outer coating selected from the group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

The vegetable cake further comprising at least one meat flavor selected from the group consisting of chicken, duck, goose, turkey, quail, rabbit, sheep, goat, cow, pig, deer, bison, buffalo, crocodile, frog, turtle, snail, worm, bacon, sausage, animal tissue, animal organ, animal tongue, animal tail, animal feet, animal liver, animal stomach, animal intestine, animal brain, animal heart, animal skin, animal tendon, animal fat, animal bone marrow, and animal blood. At least one meat flavor is used for vegetable cake in manner selected from the group consisting of outer coating, interior filing, and mixed in. At least one meat flavor is selected from group consisting of cut, uncut, slice into thin layer, cut into small pieces, and grind into small particles. At least one meat flavor can be cooked by method selected from the group consisting of deep frying, roasting, baking, steaming, boiling, grilling, and frying.

At least one meat is grinded and used as ingredient to create vegetable meat cake. The vegetable meat cake is prepared with a small amount of at least one liquid ingredient. The vegetable meat cake is having at least one binding agent selected from the group consisting of beaten egg, egg white, and starch component. The vegetable meat cake is cooked by method selected from the group consisting of deep frying, roasting, baking, boiling, steaming, grilling, and frying.

The vegetable meat cake is created in form selected from the group consisting of having no outer layer; having an outer layer of casing selected from the group consisting of intestine, and cellulose; comprising at least one outer coating selected from the group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

The vegetable cake further comprising at least one vegetable flavor selected from the group consisting of root vegetable, fruit vegetable, flower bud, flower, stem shoot, stem, leaf, bulb, legume, cereal grain, nut, seed, bean, sea vegetable, and other types of vegetable, including ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, horseradish, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, tumeric, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, chrysanthemum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizards tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, layer, mozuku, nori, ogonori, sea grape, sea lettuce, sea weed, wakame, truffle, mushroom, and bean sprout. At least one vegetable flavor is used for vegetable cake in manner selected from the group consisting of outer coating, interior filing, and mixed in. At least one vegetable flavor is in form selected from the group consisting of skin, skinned, unskinned, unshelled, cut, uncut, extract, juice, sauce, liquid, oil, gel, jelly, wax, cream, paste, powder, thin layer, and small pieces. At least one vegetable flavor can be uncooked, and cooked by method selected from the group consisting of deep frying, sun drying, roasting, baking, steaming, boiling, grilling, and frying.

The vegetable cake is created in form selected from the group consisting of having no outer layer; having an outer layer of casing selected from the group consisting of intestine, and cellulose; comprising at least one outer coating selected from the group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

The vegetable cake having a variety of shapes and sizes is selected from the group consisting of sphere, disc, tube, cube, cylinder, cone, triangle, hexagon, octagon, rectangle, and oval. The vegetable cake having a variety of shapes and sizes selected from the group consisting of cubical shape with each side of about 1 to 10 inches, spherical shape with diameter of about 1 to 100 millimeters, disc shape with diameter of about 3 to 5 inches and thickness of about ½ to 2 inches, and tube shape with diameter of about ½ to 2 inches and length of about 1 to 10 inches.

The ready to eat cold vegetable cake product with spherical shape having diameter of about 1 to 10 millimeters is created as vegetable bubble. The vegetable bubble is cooked by method selected from the group consisting of deep frying, roasting, baking, steaming, boiling, grilling, and frying.

The ready to eat cold vegetable cake product with spherical shape having diameter of about 10 to 40 millimeters is created as vegetable ball. The vegetable ball is cooked by method selected from the group consisting of deep frying, roasting, baking, steaming, boiling, grilling, and frying.

The vegetable ball is created in form selected from the group consisting of spherical shape without an outer layer; spherical shape with an outer layer of casing selected from the group consisting of intestine, and cellulose; spherical shape comprising at least one outer coating selected from the group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

The spherical shape and variety of shapes and sizes are mixable in drink, food, and condiment; and are mixable in ingredient selected from the group consisting of yogurt, ice cream, cake, rice, mashed potato, pasta, noodle, salad dressing, sauce, spread, beverage, distilled water, mineral water, sports drink, tea drink, flower tea, root tea, herbal tea, mushroom tea, green tea, oolong tea, black tea, white tea, yellow tea, earl grey, darjeeling, coffee drink, soup stock, roasted cereal grain beverage, roasted nut and seed beverage, roasted bean beverage, malted drink, fruit juice, vegetable juice, fruit drink, vegetable drink, fruit skin drink, vegetable skin drink, plant drink, herb drink, soft drink, fruit punch, beer, wine, liquor, spirit, cocktail, alcoholic drink, yogurt drink, milk drink, mammal milk, plant milk, milk shake, whole milk, lowfat milk, nonfat milk, lactaid milk, chocolate milk, buttermilk, malted milk, soy milk, coconut milk, almond milk, and vanilla milk.

The ready to eat cold vegetable cake product with disc shape having diameter of about 1½ to 5 inches and thickness of about ⅓ to 2 inches is created as vegetable patty. The vegetable patty is used to make burger. The vegetable patty is cooked by method selected from the group consisting of deep frying, roasting, baking, steaming, boiling, grilling, and frying.

The vegetable patty is created in form selected from the group consisting of disc shape without an outer layer; disc shape with an outer layer of casing selected from the group consisting of intestine, and cellulose; disc shape comprising at least one outer coating selected from the group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

The ready to eat cold vegetable cake product with tube shape having diameter of about ½ to 2 inches and length of about 1 to 10 inches is created as vegetable sausage. The vegetable sausage is used to make hot dog. The vegetable sausage is cooked by method selected from the group consisting of deep frying, roasting, baking, steaming, boiling, grilling, and frying.

The vegetable sausage is created in form selected from the group consisting of tube shape without an outer layer; tube shape with an outer layer of casing selected from the group consisting of intestine, and cellulose; tube shape comprising at least one outer coating selected from the group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

The ready to eat cold vegetable cake product is packaged as individual package and multiple package. The packaging can be in air tight container. And the packaging is selected from the group consisting of paper, plastic, metal, and glass.

Examples: an example of vegetable cake is made with potato, milk and gelatin. Another example of vegetable cake is made with oat, almond milk and gelatin. Yet another example of vegetable cake is made with macadamia, yogurt drink, and gelatin. And yet another example of vegetable cake is made of pine nut, coffee, and gelatin. An example of sweet vegetable cake is made with corn, almond, soy milk, honey, ginseng, lime juice and gelatin. Another example of sweet vegetable cake is made with rice, coconut milk, sugar, butter, beeswax, and beaten egg. An example of fruity vegetable cake is made with yam, milk, apple juice, sago, and gelatin. Another example of fruity vegetable cake is made with walnut, malted milk, cranberry juice, and gelatin. An example of salty vegetable cake is made with taro, soy milk, bacon, onion, salt, garlic, olive oil, gelatin, and corn starch. Another example of salty vegetable cake is made with pistachio, chicken soup stock, basil, salt, sesame oil, and gelatin. An example of salty and spicy vegetable cake is made with turnip, milk, shrimp, salt, ginger, chili, vinegar, fish liver oil, and gelatin. Another example of salty and spicy vegetable cake is made with barley, octopus, cheese, ginger, chili, olive oil, and gelatin. Many other examples can be produced; however these provide a general exemplary means for preparing the present invention.

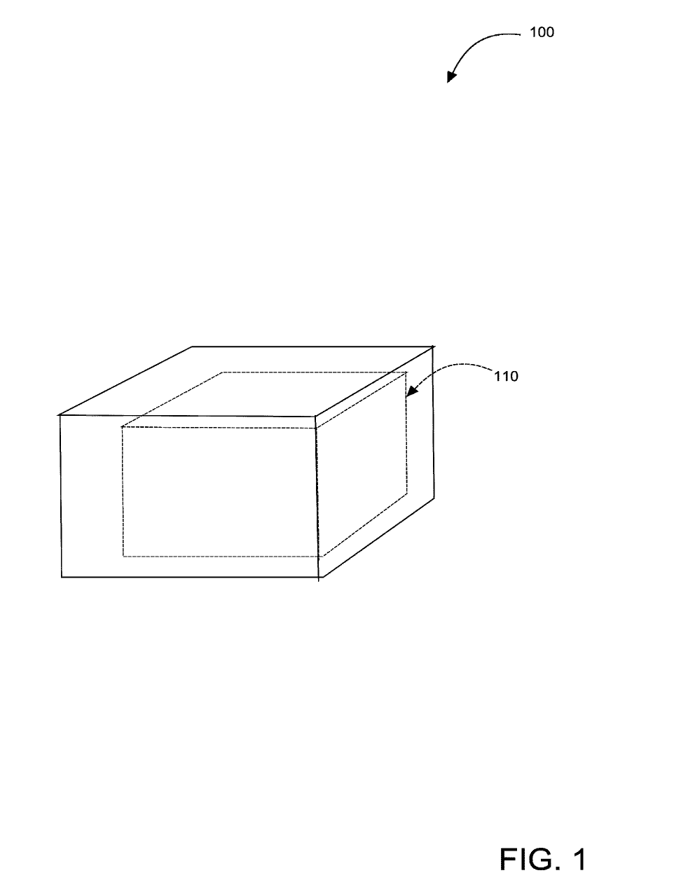

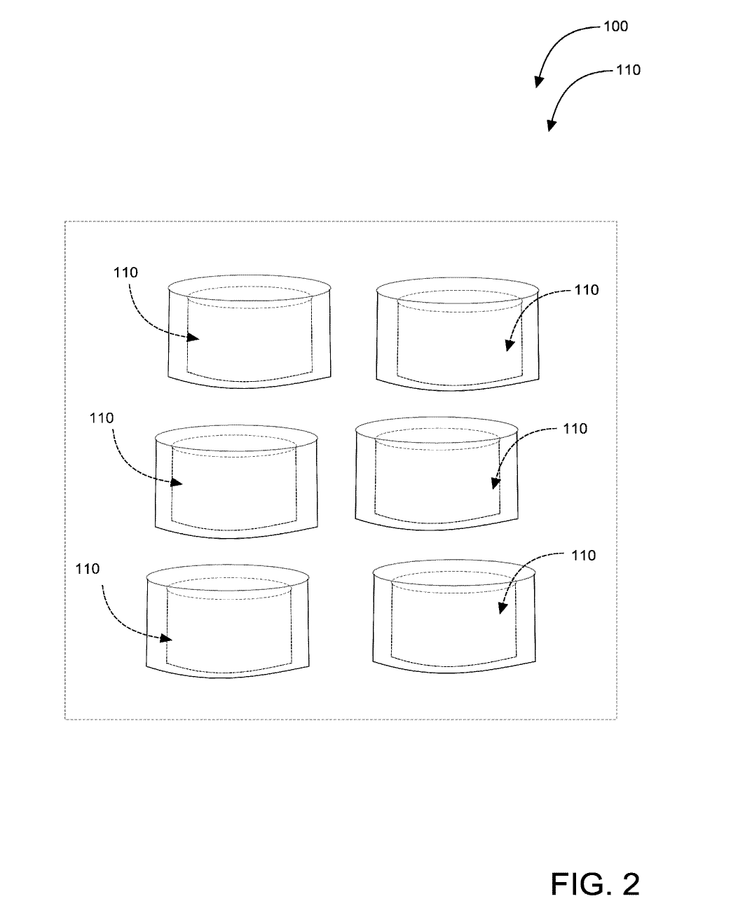

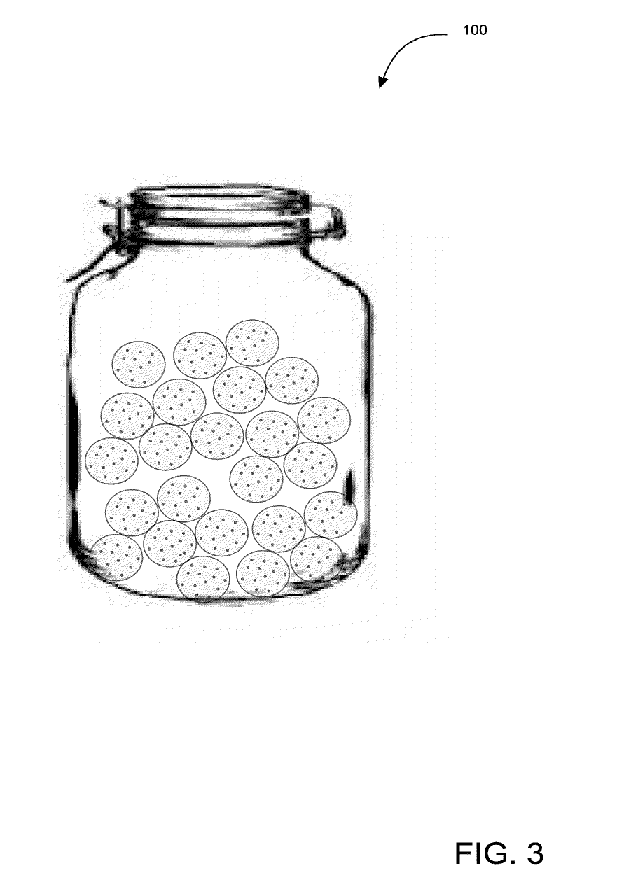

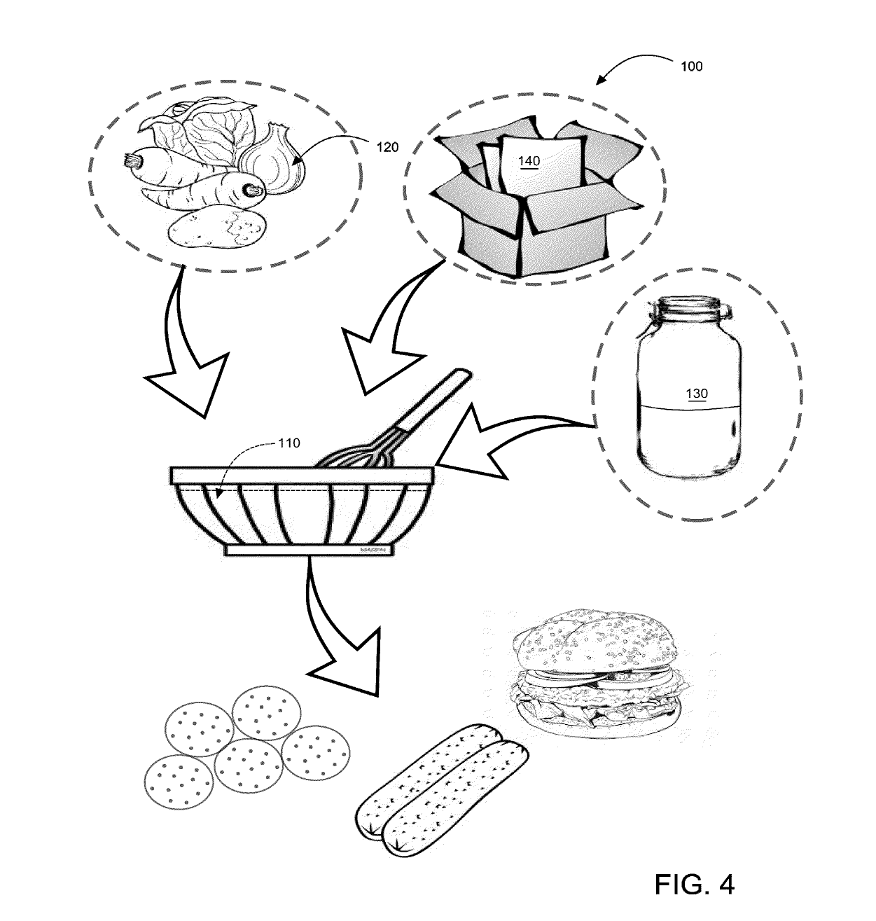

Referring to the drawings by numerals of reference there is shown in FIGS. 1-4, perspective views illustrating ready to eat cold vegetable cakes 110 according to embodiments of the present invention.

Ready to eat cold vegetable cakes with ingredients product 100 comprises vegetable cake 110, having at least one vegetable 120, at least one liquid ingredient 130, and at least one binding agent 140; wherein at least one vegetable 120, at least one liquid ingredient 130, and at least one binding agent 140 are stirred and mixed as an admixture, and cooked to form vegetable cake 110 as ready to eat cold vegetable cakes with ingredients product 100.

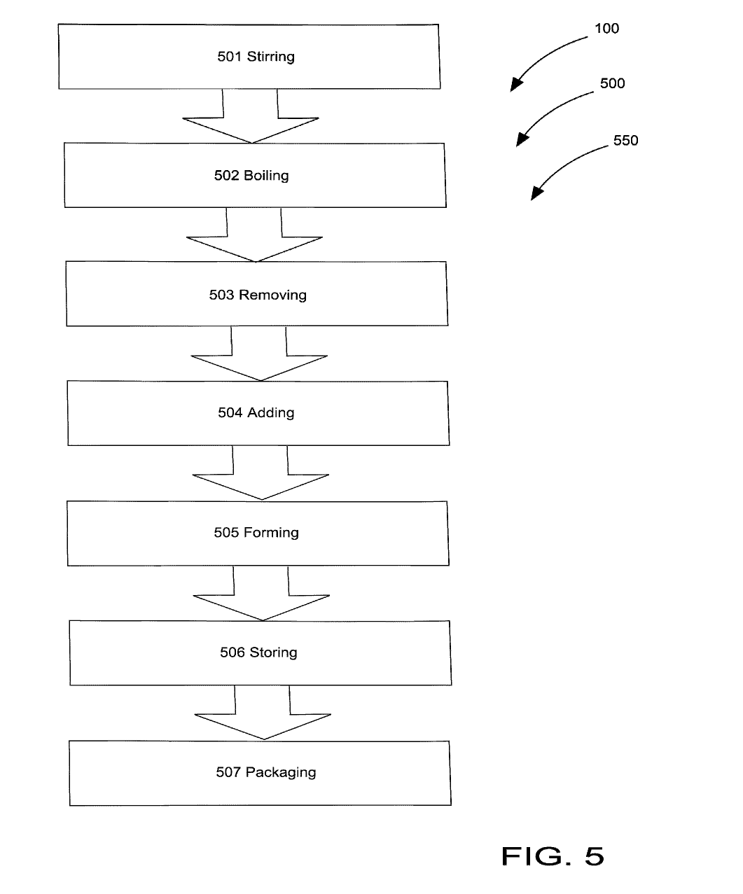

Referring now to FIG. 5, a flowchart 550 illustrating method of preparing 500 ready to eat cold vegetable cakes 110 according to an embodiment of the present invention of FIGS. 1-4.

Method of preparing 500 ready to eat cold vegetable cakes with ingredients 100 comprises the steps of: step one 501 stirring and mixing at least one vegetable 120 with at least one liquid ingredient 130; step two 502 boiling until the texture of the admixture is soft and smooth; step three 503 removing remaining solid residue; step four 504 adding ingredient, flavoring, and at least one binding agent 140 as an admixture; step five 505 forming vegetable cake 110; step six 506 storing vegetable cake 110 in a refrigerator to congeal and solidify; and optionally step seven 507 packaging to preserve freshness once solidified.

It should be noted that step 507 is an optional step and may not be implemented in all cases. Optional steps of method 500 are illustrated using dotted lines in FIG. 5 so as to distinguish them from the other steps of method 500.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat cold vegetable cake product comprising:
a vegetable cake, having
at least one vegetable,
at least one liquid ingredient, and
at least one binding agent;
wherein said vegetable cake is soft in texture, high in nutrition, and suitable for consumption by everybody, including animal, infant, small children, old people, and sick people; and
wherein said vegetable cake can be served as breakfast, lunch, snack, and dinner.

2. The ready to eat cold vegetable cake product of claim 1 wherein said vegetable cake with gelatin as said at least one binding agent can be refrigerated to serve cold but not reheated because gelatin from fish and animal congeals below 15 degrees Celsius; and said vegetable cake with said at least one binding agent selected from group consisting of beaten egg, egg white, and starch component can be served at room temperature, refrigerated to serve cold, and reheated to serve hot.

3. The ready to eat cold vegetable cake product of claim 1 wherein said at least one vegetable having preparation selected from group consisting of removing outer shell, peeling outer layer, cut, uncut, slice into thin layer, grind into small particles, and cut into small pieces.

4. The ready to eat cold vegetable cake product of claim 1 wherein said at least one vegetable is cooked by method selected from group consisting of deep frying, boiling, steaming, roasting, frying, grilling, and baking, in order to soften the texture.

5. The ready to eat cold vegetable cake product of claim 1 wherein said at least one vegetable is stirred, mixed, and cooked with said at least one liquid ingredient until texture is soft and smooth, and any solid residues are removed.

6. The ready to eat cold vegetable cake product of claim 1 wherein said at least one vegetable, said at least one liquid ingredient, and said at least one binding agent are stirred and mixed as an admixture; and said vegetable cake is cooked by method selected from group consisting of deep frying, boiling, steaming, roasting, frying, grilling, and baking.

7. The ready to eat cold vegetable cake product of claim 1 wherein said at least one vegetable is selected from group consisting of root vegetable, fruit vegetable, flower bud, flower, stem shoot, stem, leaf, bulb, cereal grain, nut, seed, bean, sea vegetable, and other types of vegetable; said root vegetable is starchy and selected from group consisting of ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, horseradish, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, tumeric, turnip, ulluco, wasabi, water caltrop, water chestnut, yalcon, and yam; said fruit vegetable is selected from group consisting of avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, and courgette; said flower and flower bud are selected from group consisting of artichoke, broccoli, caper, cauliflower, courgette flower, globe artichoke, and squash blossom; said stem and stem shoot are selected from group consisting of asparagus, prussian asparagus, bamboo shoot, celery, leek, wild leek, lemongrass, rhubarb, cardoon, kurrat, and galangal; said leaf is selected from group consisting of amaranth, arugula, beet green, bok choy, borage, broccoli rabe, brussel sprout, cabbage, catsear, celery, celtuce, chard, chaya, chickweed, chicory, chinese mallow, chive, choi sum, chrysanthemum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizard's tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, and yao choy; said bulb is selected from group consisting of cardoon, chive, florence fennel, elephant garlic, garlic, garlic chive, kohlrabi, onion, pearl onion, potato onion, spring onion, tree onion, welsh onion, quamash, scallion, and shallot; said cereal grain is selected from group consisting of rice, barley, oat, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, and wattleseed; said nut and seed are selected from group consisting of almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, and hemp seed; said bean is selected from group consisting of green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, and wisteria; said sea vegetable is selected from group consisting of aonori, arame, carola, caulerpa, dabberlocks, dulse, hijiki, kombu, layer, mozuku, nori, ogonori, sea grape, sea lettuce, sea weed, and wakame; and said other types of vegetable is selected from group consisting of truffle, mushroom, and bean sprout.

8. The ready to eat cold vegetable cake product of claim 1 wherein said at least one liquid ingredient is selected from group consisting of beverage, distilled water, mineral water, sports drink, tea drink, flower tea, root tea, herbal tea, mushroom tea, green tea, oolong tea, black tea, white tea, yellow tea, earl grey, darjeeling, coffee drink, soup stock, roasted cereal grain beverage, roasted nut and seed beverage, roasted bean beverage, malted drink, fruit juice, vegetable juice, fruit drink, vegetable drink, fruit skin drink, vegetable skin drink, plant drink, herb drink, soft drink, fruit punch, beer, wine, liquor, spirit, cocktail, alcoholic drink, yogurt drink, milk drink, mammal milk, plant milk, milk shake, whole milk, lowfat milk, nonfat milk, lactaid milk, chocolate milk, buttermilk, malted milk, soy milk, coconut milk, almond milk, and vanilla milk.

9. The ready to eat cold vegetable cake product of claim 1 wherein said at least one binding agent is an edible binder and is selected from group consisting of protein component and starch component; said protein component having ingredient selected from group consisting of gelatin, beaten egg, and egg white; said starch component having ingredient selected from group consisting of vegetable gum, vegetable starch, and vegetable flour; said vegetable gum having ingredient selected from group consisting of agar, alginic acid, sodium alginate, carrageenan, gum arabic, gum ghatti, gum tragacanth, karaya gum, guar gum, locust bean gum, beta glucan, chicle gum, dammar gum, glucomannan gum, mastic gum, psyllium seed husk, spruce gum, tara gum, gellan gum, and xanthan gum; said vegetable starch and vegetable flour having ingredient selected from group consisting of root vegetable, cereal grain, nut, seed, bean, pectin, sago, and tapioca; said ingredient can be cooked by method selected from group consisting of mixing with water, boiling, and steaming; and said gelatin from fish and animal congeals below 15 degrees Celsius.

10. The ready to eat cold vegetable cake product of claim 1 wherein said at least one binding agent selected from group consisting of beaten egg and egg white is used to create vegetable egg cake; said vegetable egg cake can be cooked by method selected from group consisting of deep frying, roasting, baking, steaming, boiling, grilling, and frying.

11. The ready to eat cold vegetable cake product of claim 10 wherein said vegetable egg cake is created in form selected from group consisting of having no outer layer; having an outer layer of casing selected from group consisting of intestine, and cellulose; comprising at least one outer coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

12. The ready to eat cold vegetable cake product of claim 1 wherein said vegetable cake further comprising at least one flavoring ingredient causing said vegetables cake to be flavored for consumption, and selected from group consisting of natural flavor, artificial flavor, fruit flavor, plant flavor, herb flavor, tea flavor, root flavor, flower flavor, flower bud flavor, pollen flavor, leaf flavor, stem flavor, stem shoot flavor, bulb flavor, seed flavor, nut flavor, bean flavor, cereal grain flavor, fruit skin flavor, vegetable oil flavor, vegetable fat flavor, vegetable skin flavor, and vegetable flavor, including hop, menthol, cordyceps, echinacea, elder, horehound, mallow, sage, thyme, cowslip, burnet, yarrow, marsh mallow, lady's mantle, speedwell, plantain, linden flowers, wild thyme, hyssop, eucalyptus, sea buckthorn, elder blossom, verbena, lemon balm, clove, coriander, cumin, basil, dill, rosemary, parsley, fennel, oregano, allspice, catnip, wormwood, musk, chili, horseradish, tumeric, mustard, curry, wasabi, mountain mint, peppermint, spearmint, wintergreen, cinnamon, licorice, rose, jasmine, chamomile, chrysanthemum, lavender, acacia, safflower, vanilla, alfafa, apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, lllawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, manila, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortiño, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, zig zag vine, ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, horseradish, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, tumeric, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, chrysanthemum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizard's tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, layer, mozuku, nori, ogonori, sea grape, sea lettuce, sea weed, wakame, truffle, mushroom, bean sprout, acai, aloe vera, arnica, ashoka, asthma weed, astragalus, barberry, belladonna, bitter leaf, bitter orange, black cohosh, blessed thistle, cat's claw, cayenne, chaparral, chasteberry, cinchona, coffee senna, comfrey, digitalis, dong quai, ephedra, european mistletoe, evening primrose, fenugreek, feverfew, flaxseed, gingko, goldenseal, hoodia, horse chestnut, horsetail, jamaica dogwood, kava, khat, konjac, kratom, kanna, licorice root, marigold, moringa oleifera, milk thistle, neem, opium poppy, purple coneflower, passion flower, red clover, syrian rue, st john's wort, saw palmetto, tea tree oil, thunder god vine, tulasi, turmeric, umckaloabo, valerian, white willow, yerba santa, ajwain, akudjura, alexanders, alkanet, alligator pepper, angelica, anise, anise hyssop, aniseed myrtle, annatto, apple mint, artemisia, asafoetida, asarabacca, avens, avocado leaf, barberry, bay leaf, bee balm, boldo, borage, black cardamom, blue fenugreek, caraway, cardamom, cassia, cayenne pepper, celery leaf, celery seed, chervil, chicory, cicely, cilantro, clary, costmary, cubeb pepper, cudweed, culantro, curry leaf, curry plant, dill seed, epazote, fenugreek, file powder, fingerroot, galangal, galingale, ganoderma, golpar, grains of paradise, grains of selim, houttuynia cordata, huacatay, Indonesian bay leaf, jimbu, kaffir lime leaves, kala zeera, kawakawa seeds, kencur, keluak, kinh gioi, kokam seed, korarima, koseret leaves, lemon myrtle, lemon ironbark, lemon verbena, leptotes bicolor, lesser calamint, lime flower, lovage, mahlab, marjoram, mastic, mountain horopito, musk mallow, nasturtium, nigella, njangsa, neem, olida, orris root, pandan flower, pandan leaf, paprika, paracress, peppermint gum leaf, perilla, pandanus amaryllifolius, quassia, ramsons, rice paddy herb, rue, saffron, salad burnet, salep, sassafras, savory, silphium, shiso, sorrel, spikenard, star anise, sumac, sweet woodruff, tarragon, voatsiperifery, water-pepper, wattleseed, wild betel, willow herb, wood avens, and woodruff; said at least one flavoring ingredient is used for said vegetable cake in manner selected from group consisting of outer coating, interior filing, and mixed in; said at least one flavoring ingredient is in form selected from group consisting of skin, skinned, unskinned, unshelled, cut, uncut, extract, juice, sauce, liquid, oil, gel, jelly, wax, cream, paste, powder, thin layer, and small pieces; and said at least one flavoring ingredient can be uncooked, and cooked by method selected from group consisting of deep frying, sun drying, roasting, baking, steaming, boiling, grilling, and frying.

13. The ready to eat cold vegetable cake product of claim 1 wherein said vegetable cake further comprising at least one fruit flavor to make fruity flavored cake selected from group consisting of apple, orange, lemon, lime, grapefruit, grape, guava, plum, peach, pear, blackberry, blueberry, strawberry, cranberry, raspberry, cherry, mango, pineapple, pomegranate, papaya, watermelon, rockmelon, hamimelon, melon, honeydew, coconut, durian, passion fruit, banana, fig, apricot, mandarin, blackcurrant, starfruit, kiwi, pomelo, lychee, loquat, persimmon, tangerine, mangosteen, noni, sugar apple, mulberry, elderberry, gooseberry, lingonberry, juniper berry, jackfruit, dragonfruit, abiu, acai, acerola, ackee, cherry orange, moringa, ambarella, araza, arhat, atemoya, atherton raspberry, babaco, bacupari, bacuri, bael, barbadine, beach plum, batuan, bearberry, bignay, bilberry, bilimbi, biriba, black apple, black cherry, black raspberry, black mulberry, black sapote, blood orange, bolwarra, boquila, blue tongue, breadfruit, broad leaf bramble, buddha's hand, buffaloberry, brush cherry, burdekin plum, bush tomato, button mangosteen, caimito, calabash tree, calamondin, calamansi, camucamu, canary melon, canistel, cape gooseberry, capuli cherry, carambola, cardon, carob, cashew apple, cassabanana, cattley guava, cawesh, cedar bay cherry, ceriman, cereus peruvianus, charichuelo, chayote, che, chempedak, chenet, cherimoya, cherry ballart, chokeberry, chokecherry, chupa chupa, citron, clementine, cloudberry, cluster fig, cocky apple, coco plum, cocona, cocoplum, coffee cherry, common apple berry, conkerberry, cornelian cherry, crowberry, cupuacu, currant, curry leaf apple, custard apple, elephant apple, key apple, damson plum, date, date plum, davidson's plum, dead man's finger, desert banana, desert fig, desert lime, dodder laurel, doubah, double coconut, duku, eastern may hawthorn, emu apple, emu berry, false mastic, feijoa, fibrous satinash, finger lime, florida strangler fig, gac, galia melon, gambooge, genip, giant granadilla, otaheite gooseberry, goumi, governor's plum, montessa granadilla, yellow granadilla, greengage, grumichama, guanabana, guarana, cattley guava, pineapple guava, purple guava, strawberry guava, guavaberry, hackberry, hairless rambutan, hardy kiwi, hawthorn, hog plum, honeysuckle, horned melon, huckleberry, huito, ice cream bean, llama, lllawarra plum, imbe, jabuticaba, jambul, jatoba, jelly palm, jocote, jujube, kabosu, kaffir lime, kahikatea, kakadu lime, kakadu plum, kapok, karkalla, karonda, kei apple, kepel fruit, keule, key lime, kitembilla, korlan, kumquat, kutjera, kwai muk, lady apple, lakoocha, langsat, lanzone, lapsi, lardizabala, lemon aspen, leucaena, lillypilly, little gooseberry tree, limequat, loganberry, longan, lucuma, ma praang, mabolo, madrono, malabar plum, mamey sapote, mamoncillo, mangaba, manoao, maqui, marang, marula, mayapple, malay apple, mammee apple, maypop, medlar, melinjo, melon pear, midyim, miracle fruit, mock strawberry, purple mombin, red mombin, yellow mombin, monstera, mora de castilla, morinda, morinda citrifolia, mortiño, mountain pepper, mountain soursop, wild plum, mundu, muntries, muscadine, muskmelon, naartjie, nageia, nance, nannyberry, naranjilla, neem, nere, nonda plum, nungu, oil palm, oregan grape, oroblanco, otaheite gooseberry, palmyra palm, pawpaw, peachpalm, peanut butter fruit, pepino, pequi, peumo, phalsa, pigeon pea, pigeon plum, pigface, pindo palm, pineapple guava, pitomba, pois doux, pommecythere, pommerac, prickly pear, prune, pulasan, pummelo, pupunha, purple apple berry, purple granadilla, quandong, queensland ebony, quince, raisin tree, rambutan, red granadilla, red mulberry, rhubarb, riberry, rimu, rollinia, rose apple, rose hip, rose leaf bramble, rose myrtle, rowan, safou, sageretia, saguaro, salak, salal, salmonberry, sandpaper fig, santol, mamey, sapodilla, fibrous satinash, saskatoonberry, saw palmetto, sea buckthorn, serviceberry, shipova, small leaf tamarind, snow berry, soncoya, servicetree, soursop, southern crabapple, spanish lime, spanish tamarind, spiny monkey orange, star apple, carambola, strawberry guava, ugni, strawberry pear, surinam cherry, sweet apple berry, sweet ganadilla, sweet lemon, sweet orange, sweet pepper, sweetsop, sycamore fig, tamarillo, tamarind, monkey tamarind, velvet tamarind, tanjong, texas persimmon, thimbleberry, totara, toyon, wampee, water apple, wax apple, wax jambu, acerola, white aspen, white mulberry, white sapote, wild grape, wild orange, wild peach, wild plum, wild mangosteen, wineberry, wolfberry, wongi, wood apple, yangmei, yellow plum, yew, youngberry, and zig zag vine; said at least one fruit flavor is used for said vegetable cake in manner selected from group consisting of outer coating, interior filing, and mixed in; said at least one fruit flavor is in form selected from group consisting of skin, skinned, unskinned, unshelled, cut, uncut, extract, juice, sauce, liquid, oil, gel, jelly, wax, cream, paste, powder, thin layer, and small pieces; and said at least one fruit flavor can be uncooked, and cooked by method selected from group consisting of deep frying, sun drying, roasting, baking, steaming, boiling, grilling, and frying.

14. The ready to eat cold vegetable cake product of claim 1 wherein said vegetable cake further comprising at least one other flavoring ingredient selected from group consisting of natural flavor, artificial flavor, artificial sweetener, salt, vinegar, sugar, syrup, honey, fudge, chocolate, royal jelly, jelly, pudding, custard, ice cream, gelato, sherbet, cake, biscuit, cookie, candy, crepe, pancake, donut, roll, pie, pastry, waffle, pita, tortilla, bread, taco, marshmallow, caramel, butterscotch, raisin, apple sauce, vegetable shortening, vegetable oil, vegetable fat, fish oil, fish liver oil, plant wax, animal wax, beeswax, carnauba wax, cream, sour cream, yogurt, butter, margarine, peanut butter, cheese, cream cheese, cottage cheese, mozzarella, mascarpone, ricotta, egg, glycerol, suet, lard, and malt; said at least one other flavoring ingredient is used for said vegetable cake in manner selected from group consisting of outer coating, interior filing, and mixed in; and said at least one other flavoring ingredient is in form selected from group consisting of extract, juice, sauce, liquid, oil, gel, jelly, wax, cream, paste, powder, thin layer, and small pieces.

15. The ready to eat cold vegetable cake product of claim 1 wherein said vegetable cake further comprising at least one nutritional ingredient which is essential nutrient selected from group consisting of vitamin, dietary mineral, amino acid, and fatty acid; said vitamin includes vitamin A, vitamin B1, vitamin B2, vitamin B3, vitamin B5, vitamin B6, vitamin B7, vitamin B9, vitamin B12, vitamin C, vitamin D, vitamin E, and vitamin K; said dietary mineral includes calcium, phosphorus, potassium, sulfur, sodium, chlorine, magnesium, iron, cobalt, copper, zinc, molybdenum, iodine, selenium, manganese, nickle, chromium, fluorine, boron, and strontium; said amino acid includes histidine, isoleucine, leucine, lysine, methionine, cysteine, phenylalanine, tyrosine, threonine, tryptophan, and valine; said fatty acid includes alpha-linoleic acid, and linoleic acid; said at least one nutritional ingredient is used for said vegetable cake in manner selected from group consisting of outer coating, interior filing, and mixed in; and said at least one nutritional ingredient is in form selected from group consisting of extract, juice, sauce, liquid, oil, gel, jelly, wax, cream, paste, powder, thin layer, and small pieces.

16. The ready to eat cold vegetable cake product of claim 1 wherein said vegetable cake further comprising at least one health ingredient which includes medication and other health ingredient; said medication is mixed into said vegetable cake for ease of consumption; said other health ingredient is selected from group consisting of electrolyte, lactase, yeast, propolis, and quinine; and said at least one health ingredient is in form selected from group consisting of extract, juice, sauce, liquid, oil, gel, jelly, wax, cream, paste, powder, thin layer, and small pieces.

17. The ready to eat cold vegetable cake product of claim 1 wherein said vegetable cake further comprising at least one food additive selected from group consisting of acid, acidity regulator, alcohol, anticaking agent, antifoaming agent, antioxidant, bulking agent, coagulation agent, food coloring, color retention agent, emulsifier, flavor enhancer, flour treatment agent, gelling agent, glazing agent, humectant, leavening agent, tracer gas, preservative, stabilizer, sweetener, and thickener.

18. The ready to eat cold vegetable cake product of claim 1 wherein said vegetable cake further comprising at least one topping selected from group consisting of chocolate, caramel, butterscotch, peanut butter, butter, margarine, vegetable shortening, vegetable oil, vegetable fat, fish oil, fish liver oil, plant wax, animal wax, beeswax, carnauba wax, sugar, syrup, honey, royal jelly, apple sauce, raisin, fruit, vegetable, fruit skin, vegetable skin, herb, cereal grain, nut, seed, bean, cheese, cream cheese, cottage cheese, mozzarella, mascarpone, ricotta, jelly, pudding, custard, ice cream, gelato, sherbet, yogurt, cake, biscuit, cookie, candy, crepe, pancake, donut, roll, pie, pastry, waffle, pita, tortilla, bread, taco, marshmallow, sour cream, cream, malt, egg, meat, and seafood; said topping is in form selected from group consisting of extract, juice, sauce, liquid, oil, gel, jelly, wax, cream, paste, powder, thin layer, and small pieces; and said topping can be uncooked, and cooked by method selected from group consisting of deep frying, sun drying, roasting, baking, steaming, boiling, grilling, and frying.

19. The ready to eat cold vegetable cake product of claim 1 wherein said vegetable cake further comprising at least one salt source having a combination of ingredients selected from group consisting of seafood, meat, and cheese, including seafood and meat, seafood and cheese, meat and cheese, seafood and meat and cheese; said seafood is selected from group consisting of squid, cuttle fish, shrimp, crab, crayfish, octopus, clam, oyster, scallop, lobster, abalone, conch, jellyfish, prawn, hill, mussel, sea cucumber, sea urchin, eel, snail, shrimp roe, crab roe, lobster roe, fish roe, and fish; said meat is selected from group consisting of chicken, duck, goose, turkey, quail, rabbit, sheep, goat, cow, pig, deer, bison, buffalo, crocodile, frog, turtle, snail, worm, bacon, sausage, animal tissue, animal organ, animal tongue, animal tail, animal feet, animal liver, animal stomach, animal intestine, animal brain, animal heart, animal skin, animal tendon, animal fat, animal bone marrow, and animal blood; said at least one salt source is used for said vegetable cake in manner selected from group consisting of outer coating, interior filing, and mixed in; said at least one salt source is selected from group consisting of cut, uncut, slice into thin layer, cut into small pieces, and grind into small particles; and said at least one salt source can be cooked by method selected from group consisting of deep frying, roasting, baking, steaming, boiling, grilling, and frying.

20. The ready to eat cold vegetable cake product of claim 19 wherein said at least one salt source having a combination of ingredients is grinded to create vegetable plus salt source cake; said vegetable plus salt source cake is prepared with a small amount of said at least one liquid ingredient; said vegetable plus salt source cake is having said at least one binding agent selected from group consisting of beaten egg, egg white, and starch component; and said vegetable plus salt source cake is cooked by method selected from group consisting of deep frying, roasting, baking, boiling, steaming, grilling, and frying.

21. The ready to eat cold vegetable cake product of claim 20 wherein said vegetable plus salt source cake is created in form selected from group consisting of having no outer layer; having an outer layer of casing selected from group consisting of intestine, and cellulose; comprising at least one outer coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

22. The ready to eat cold vegetable cake product of claim 1 wherein said vegetable cake further comprising at least one seafood flavor selected from group consisting of squid, cuttle fish, shrimp, crab, crayfish, octopus, clam, oyster, scallop, lobster, abalone, conch, jellyfish, prawn, krill, mussel, sea cucumber, sea urchin, eel, snail, shrimp roe, crab roe, lobster roe, fish roe, and fish; said at least one seafood flavor is used for said vegetable cake in manner selected from group consisting of outer coating, interior filing, and mixed in; said at least one seafood flavor is selected from group consisting of cut, uncut, slice into thin layer, cut into small pieces, and grind into small particles; and said at least one seafood flavor can be cooked by method selected from group consisting of deep frying, roasting, baking, steaming, boiling, grilling, and frying.

23. The ready to eat cold vegetable cake product of claim 22 wherein said at least one seafood is grinded and used as ingredient to create vegetable seafood cake; said vegetable seafood cake is prepared with a small amount of said at least one liquid ingredient; said vegetable seafood cake is having said at least one binding agent selected from group consisting of beaten egg, egg white, and starch component; and said vegetable seafood cake is cooked by method selected from group consisting of deep frying, roasting, baking, boiling, steaming, grilling, and frying.

24. The ready to eat cold vegetable cake product of claim 23 wherein said vegetable seafood cake is created in form selected from group consisting of having no outer layer; having an outer layer of casing selected from group consisting of intestine, and cellulose; comprising at least one outer coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

25. The ready to eat cold vegetable cake product of claim 1 wherein said vegetable cake further comprising at least one meat flavor selected from group consisting of chicken, duck, goose, turkey, quail, rabbit, sheep, goat, cow, pig, deer, bison, buffalo, crocodile, frog, turtle, snail, worm, bacon, sausage, animal tissue, animal organ, animal tongue, animal tail, animal feet, animal liver, animal stomach, animal intestine, animal brain, animal heart, animal skin, animal tendon, animal fat, animal bone marrow, and animal blood; said at least one meat flavor is used for said vegetable cake in manner selected from group consisting of outer coating, interior filing, and mixed in; said at least one meat flavor is selected from group consisting of cut, uncut, slice into thin layer, cut into small pieces, and grind into small particles; and said at least one meat flavor can be cooked by method selected from group consisting of deep frying, roasting, baking, steaming, boiling, grilling, and frying.

26. The ready to eat cold vegetable cake product of claim 25 wherein said at least one meat is grinded and used as ingredient to create vegetable meat cake; said vegetable meat cake is prepared with a small amount of said at least one liquid ingredient; said vegetable meat cake is having said at least one binding agent selected from group consisting of beaten egg, egg white, and starch component; and said vegetable meat cake is cooked by method selected from group consisting of deep frying, roasting, baking, boiling, steaming, grilling, and frying.

27. The ready to eat cold vegetable cake product of claim 26 wherein said vegetable meat cake is created in form selected from group consisting of having no outer layer; having an outer layer of casing selected from group consisting of intestine, and cellulose; comprising at least one outer coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

28. The ready to eat cold vegetable cake product of claim 1 wherein said vegetable cake further comprising at least one vegetable flavor selected from group consisting of root vegetable, fruit vegetable, flower bud, flower, stem shoot, stem, leaf, bulb, legume, cereal grain, nut, seed, bean, sea vegetable, and other types of vegetable, including ahipa, arracacha, bamboo shoot, beetroot, burdock, broadleaf arrowhead, camas, canna, carrot, cassava, celeriac, chinese artichoke, daikon, earthnut pea, elephant foot yam, ensete, galangal, ginger, ginseng, hamberg parsley, horseradish, lotus root, jerusalem artichoke, jicama, mashua, parsley root, parsnip, pignut, potato, prairie turnip, radish, rutabaga, salsify, scorzonera, skirret, swede, sweet potato, taro, ti, tigernut, tumeric, turnip, ulluco, wasabi, water caltrop, water chestnut, yalcon, yam, avocado, bell pepper, bitter melon, bitter gourd, breadfruit, chayote, cucumber, ivy gourd, eggplant, aubergine, brinjal, luffa, nopal, okra, pepper, pumpkin, squash, sweet corn, sweet pepper, tinda, tomatillo, tomato, west indian gherkin, winter melon, zucchini, courgette, artichoke, broccoli, caper, cauliflower, courgette flower, globe artichoke, squash blossom, asparagus, prussian asparagus, bamboo shoot, celery, leek, wild leek, lemongrass, rhubarb, cardoon, kurrat, galangal, amaranth, arugula, beet green, bok choy, borage, broccoli rabe, brussel sprout, cabbage, catsear, celery, celtuce, chard, chaya, chickweed, chicory, chinese mallow, chive, choi sum, chrysanthemum, collard green, common purslane, corn salad, cress, dandelion, endive, fat hen, fiddlehead, fluted pumpkin, garden rocket, golden samphire, good king henry, greater plantain, kai lan, kale, komatsuna, kuka, lagos bologi, lamb's lettuce, lamb's quarters, land cress, leek, lettuce, lizard's tail, malabar spinach, melokhia, miner's lettuce, mizuna green, mustard green, napa cabbage, new zealand spinach, orache, pak choy, paracress, pea, poke, radicchio, samphire, sculpit, stridolo, sea beet, sea kale, sierra leoni bologi, soko, sorrel, spinach, summer purslane, swiss chard, tatsoi, turnip green, watercress, water spinach, wheatgrass, winter purslane, yarrow, yao choy, cardoon, chive, florence fennel, elephant garlic, garlic, garlic chive, kohlrabi, onion, pearl onion, potato onion, spring onion, tree onion, welsh onion, quamash, scallion, shallot, rice, barley, oat, rye, corn, wheat, buckwheat, millet, sorghum, spelt, quinoa, chicory, molasses, beet root, fonio, palmer's grass, teff, triticale, cattail, chia, flax, grain amaranth, canihua, pitseed goosefoot, wattleseed, almond, cashew, chestnut, coconut, hazelnut, macadamia, peanut, pecan, pine nut, pistachio, walnut, acorn, brazil nut, gingko nut, shea nut, beechnut, candlenut, kurrajong, mongongo, palm nut, karuka, red bopple nut, hickory, jacknut, pepea nut, yellow walnut, cycad, munya nut, monkey puzzle nut, paradise nut, colocynth, filbert, mamoncillo, maya nut, ogbono nut, water caltrop, juniper, podocarp, cempedak, coffee, egusi, fox nut, jackfruit, malabar gourd, nutmeg, breadnut, betel nut, cola nut, pili nut, olive, drumstick, okra, pumpkin seed, sesame seed, sunflower seed, lotus seed, hemp seed, green bean, red bean, azuki bean, black bean, back eyed bean, white bean, yellow bean, common bean, broad bean, pinto bean, soybean, lima bean, kidney bean, pea bean, potato bean, dolichos bean, moth bean, mung bean, ricebean, runner bean, tepary bean, urad bean, velvet bean, winged bean, yardlong bean, chickpea, pigeon pea, snap pea, snow pea, lentil, lupin, tarwi, carob, guar, horse gram, cocoa bean, coffee bean, bambara groundnut, cowpea, hyacinth bean, lablab, moringa oleifera, sterculia, yam bean, alfalfa, clover, mesquite, carob, tamarind, wisteria, aonori, arame, carola, caulerpa, dabberlocks, dulse, hijiki, kombu, layer, mozuku, nori, ogonori, sea grape, sea lettuce, sea weed, wakame, truffle, mushroom, and bean sprout; said at least one vegetable flavor is used for said vegetable cake in manner selected from group consisting of outer coating, interior filing, and mixed in; said at least one vegetable flavor is in form selected from group consisting of skin, skinned, unskinned, unshelled, cut, uncut, extract, juice, sauce, liquid, oil, gel, jelly, wax, cream, paste, powder, thin layer, and small pieces; and said at least one vegetable flavor can be uncooked, and cooked by method selected from group consisting of deep frying, sun drying, roasting, baking, steaming, boiling, grilling, and frying.

29. The ready to eat cold vegetable cake product of claim 1 wherein said vegetable cake is created in form selected from group consisting of having no outer layer; having an outer layer of casing selected from group consisting of intestine, and cellulose; comprising at least one outer coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

30. The ready to eat cold vegetable cake product of claim 1 wherein said vegetable cake having a variety of shapes and sizes is selected from group consisting of sphere, disc, tube, cube, cylinder, cone, triangle, hexagon, octagon, rectangle, and oval; said vegetable cake having a variety of shapes and sizes selected from group consisting of cubical shape with each side of about 1 to 10 inches, spherical shape with diameter of about 1 to 100 millimeters, disc shape with diameter of about 3 to 5 inches and thickness of about ½ to 2 inches, and tube shape with diameter of about ½ to 2 inches and length of about 1 to 10 inches.

31. The ready to eat cold vegetable cake product of claim 30 wherein said spherical shape having diameter of about 1 to 10 millimeters is created as vegetable bubble; and said vegetable bubble is cooked by method selected from group consisting of deep frying, roasting, baking, steaming, boiling, grilling, and frying.

32. The ready to eat cold vegetable cake product of claim 30 wherein said spherical shape having diameter of about 10 to 40 millimeters is created as vegetable ball; and said vegetable ball is cooked by method selected from group consisting of deep frying, roasting, baking, steaming, boiling, grilling, and frying.

33. The ready to eat cold vegetable cake product of claim 32 wherein said vegetable ball is created in form selected from group consisting of spherical shape without an outer layer; spherical shape with an outer layer of casing selected from group consisting of intestine, and cellulose; spherical shape comprising at least one outer coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

34. The ready to eat cold vegetable cake product of claim 30 wherein said spherical shape and said variety of shapes and sizes are mixable in drink, food, and condiment; and are mixable in ingredient selected from group consisting of yogurt, ice cream, cake, rice, mashed potato, pasta, noodle, salad dressing, sauce, spread, beverage, distilled water, mineral water, sports drink, tea drink, flower tea, root tea, herbal tea, mushroom tea, green tea, oolong tea, black tea, white tea, yellow tea, earl grey, darjeeling, coffee drink, soup stock, roasted cereal grain beverage, roasted nut and seed beverage, roasted bean beverage, malted drink, fruit juice, vegetable juice, fruit drink, vegetable drink, fruit skin drink, vegetable skin drink, plant drink, herb drink, soft drink, fruit punch, beer, wine, liquor, spirit, cocktail, alcoholic drink, yogurt drink, milk drink, mammal milk, plant milk, milk shake, whole milk, lowfat milk, nonfat milk, lactaid milk, chocolate milk, buttermilk, malted milk, soy milk, coconut milk, almond milk, and vanilla milk.

35. The ready to eat cold vegetable cake product of claim 30 wherein said disc shape having diameter of about 1½ to 5 inches and thickness of about ⅓ to 2 inches is created as vegetable patty; said vegetable patty is used to make burger; and said vegetable patty is cooked by method selected from group consisting of deep frying, roasting, baking, steaming, boiling, grilling, and frying.

36. The ready to eat cold vegetable cake product of claim 35 wherein said vegetable patty is created in form selected from group consisting of disc shape without an outer layer; disc shape with an outer layer of casing selected from group consisting of intestine, and cellulose; disc shape comprising at least one outer coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

37. The ready to eat cold vegetable cake product of claim 30 wherein said tube shape having diameter of about ½ to 2 inches and length of about 1 to 10 inches is created as vegetable sausage; said vegetable sausage is used to make hot dog; and said vegetable sausage is cooked by method selected from group consisting of deep frying, roasting, baking, steaming, boiling, grilling, and frying.

38. The ready to eat cold vegetable cake product of claim 37 wherein said vegetable sausage is created in form selected from group consisting of tube shape without an outer layer; tube shape with an outer layer of casing selected from group consisting of intestine, and cellulose; tube shape comprising at least one outer coating selected from group consisting of bread crumbs, beer batter, egg batter, cornmeal batter, milk batter, yogurt batter, tea batter, coffee batter, malt batter, chocolate batter, honey batter, syrup batter, caramel batter, butterscotch batter, peanut butter batter, butter batter, margarine batter, cheese batter, cereal grain batter, nut batter, seed batter, bean batter, vegetable batter, plant batter, herb batter, fruit batter, wine batter, liquor batter, alcoholic batter, soft drink batter, soup batter, plant wax, animal wax, beeswax, carnauba wax, donut, roll, pie, pastry, waffle, crepe, pancake, pita, tortilla, bread, taco, biscuit, cookie, cake, jelly, royal jelly, cheese, cream cheese, cottage cheese, mozzarella, mascarpone, ricotta, butter, margarine, pudding, custard, candy, ice cream, gelato, sherbet, yogurt, chocolate, and fudge; having no interior filing; comprising at least one interior filing of various ingredient; having an even composition; having an uneven composition; having horizontal layers of varying composition; having vertical layers of varying composition; and having diagonal layers of varying composition.

39. The ready to eat cold vegetable cake product of claim 1 having packaging as individual package and multiple package; said packaging is in air tight container; and said packaging is selected from group consisting of paper, plastic, metal, and glass.

40. A method of preparing said ready to eat cold vegetable cake product of claim 1 comprising the steps of:
stirring and mixing said at least one vegetable with said at least one liquid ingredient;
boiling until texture of admixture is soft and smooth;
removing remaining solid residue;
adding ingredient, flavoring, and said at least one binding agent as an admixture;
forming said vegetable cake;
storing said vegetable cake in a refrigerator to congeal and solidify; and
packaging to preserve freshness once solidified.
